(19) United States
(12) Patent Application Publication
(10) Pub. No.: US 2019/0275564 A1
(43) Pub. Date: Sep. 12, 2019

(54) METHOD TO CLEAN A MOULD DRUM PROVIDED WITH A PLASTIC POROUS STRUCTURE

(71) Applicant: GEA Food Solutions Bakel B.V., Bakel (NL)

(72) Inventor: Hendrikus Petrus Gerardus Van Gerwen, Someren (NL)

(21) Appl. No.: 16/461,924

(22) PCT Filed: Nov. 27, 2017
(86) PCT No.: PCT/EP2017/080524

§ 371 Date: May 17, 2019

(30) Foreign Application Priority Data
Nov. 29, 2016 (EP) 16201240.5

(51) Int. Cl. B08B 3/00; B08B 5/00; B08B 3/10; B08B 9/08; B08B 3/08; A22C 7/00

(52) U.S. Cl. CPC B08B 3/003; B08B 5/00; B08B 3/10; B08B 2209/08; B08B 9/0821; B08B 3/08; A22C 7/0069; B08B 9/0804

(57) ABSTRACT

A mould drum with a multitude of product cavities in a multitude of rows. Each cavity has a porous bottom- and/or sidewall. The cavities in one row being connected with a passage, the passage extending parallel to the center-axis of the drum from one front end. A method to clean a mould drum and specifically a mould drum with cavities with a mould cavity wall having at least partially a porous structure particularly with interconnecting pores.

The present invention relates to a mould drum with a multitude of product cavities in a multitude of rows, each cavity having a porous bottom- and/or sidewall, the cavities in one row being connected with a passage, the passage extending parallel to the center-axis of the drum from one front end. The present invention further relates to a method to clean a mould drum and specifically a mould drum with cavities with a mould cavity wall having at least partially a porous structure particularly with interconnecting pores. The cleaning methods described in this document are directed to and suitable for cleaning plastic porous structures, however, the described cleaning methods are not limited to plastic but are also useful in cleaning for instance stainless steel porous structures.

It is known to utilize mould drums for moulding food products, particularly products for human consumption, such as meat products, meat replacement products, fish, dairy, potatoes and vegetable products and pet food. The moulding takes place in mould cavities, into which the food mass is pressed and from which the moulded product is released. Advantageously, the cavity is at least partially made from a porous material, so that the air in the cavity can be vented during filling and/or that the formed product can be released with a pressurized fluid. It has been prevented that the porous structure is be clogged by food mass during the moulding process and thereby reducing the product output of the mould member. Further it is important that all machinery, tools and parts used in the food processing industry will be cleaned regularly and in a sufficient manner in order to fulfill the hygienic demands.

Nowadays, mould drums, particularly mould cavities, which are at least partially made from a plastic material become more and more popular. However, plastic porous structures have a number of disadvantageous material properties compared to stainless steel porous structures, in particular the mechanical properties like tensile strength, yield strength, stiffness, hardness, fatigue, thermal properties like thermal expansion, melting point, chemical properties like reactivity and/or optical/color properties. When cleaning a mould member provided with at least partially porous plastic cavities all these properties need to be considered.

Apparatus and methods to clean a mould member and specifically a mould drum by physical cleaning in combination with chemical cleaning are described for example in WO2005/107481 and WO2012/084215. Both patent applications are in particular directed to mould members provided with at least partially porous sintered stainless steel cavities. While the apparatus described in both applications can also be used for a plastic porous structure, the described methods need to be different in order to prevent that the physical/chemical cleaning process will damage the pore structure such that the permeability and/or lifetime of the mould member will decrease. However, even for a steel porous material, the apparatus and method is not always sufficient.

It was therefore the objective of the present invention to provide a mould drum that can be easily cleaned and/or a method to clean a mould drum that can be easily executed.

The problem is attained with a mould drum with a multitude of product cavities in a multitude of rows, each cavity having a porous bottom- and/or sidewall the cavities in one row being connected with a passage, the passage extending parallel to the center-axis of the drum from one front end, wherein for cleaning, each passage is connected to a two phase cleaning material source.

The disclosure made regarding this embodiment of the present invention also applies to other embodiments and vice versa. The disclosure made regarding this subject matter of the present invention can be combined with other subject matters of the present invention.

The present invention relates to a mould drum with a multitude of product cavities at its circumference, provided in a multitude of rows, each row extending preferably parallel to the longitudinal center axis of the drum. The drum and the cavities can be made of any material or combination of different materials that have sufficient strength to withstand the mechanical forces occurring during the moulding process. Furthermore, the material must be acceptable for the food production. Plastic, like PE, PET, UHMW-PE at least for the porous is a preferred material. Preferably, each cavity comprises an at least partially porous plastic bottom wall and/or an at least partially porous plastic sidewall. Each cavity is, during production of moulded products, connected to a fluid passage which is connected to the ambient or a vacuum and which extends from one front end of the mould drum, preferably from the first front end to the second front end, in longitudinal direction of the mould drum, i.e. parallel to the center axis of the drum. Depending on the design of the mould drum, further channels can be provided which connect the passages to the individual cavities. Each channel is designed to carry a gas a liquid and/or a mixture of both.

During production of moulded products, the drum rotates in the food forming apparatus and the at least partly porous cavities will be filled with food mass. Via the porous structure and fluid passage connected to the cavities which are filled, venting of the cavities, as a result of pressure applied to the meat and/or vacuum, to the ambient can take place with result that the formed products are free of air pockets and/or that each cavity is completely filled with food product. During discharge of the formed products a compressed fluid, preferably air, can be forced through the passage and the porous structure of the product cavities to remove the formed products from the cavity. A cleaning fluid will be forced through the passages and porous structure during cleaning.

The mould member can be cleaned either on the food forming apparatus and/or a cleaning apparatus positioned remote from the food forming apparatus, wherein the second alternative is preferred, so that the production of moulded products can continue while the respective mould drum is cleaned.

During cleaning, the drum rotates and/or is in a standstill position. For cleaning of the outer circumference of the drum, preferably a spray bar with a multitude of nozzles is utilized. Whether the drum rotates during cleaning or not determines whether the spray bar is rotating and/or in a standstill position. In order to clean the plastic porous structure, fluid can be direct to each passage separately or to all passages at once in order to reduce cleaning time. The latter can be done by a distributor inside the cleaning apparatus and/or inside the drum. The inventive cleaning method is not limited to the location where the cleaning takes place and not to the mechanical embodiment of the used apparatus.

The plastic porous structure can be made of, but is not limited to, UHMW-PE. UHMW-PE is preferred due to its availability, cost price, machinability, durability, abrasion and excellent resistance to a large number of chemicals. In order to be able to detect plastic in case pieces break off from the mould member, the used plastic can be provided with small metal particles, particularly nano-particles.

During production, the food mass is forced into the cavity of the mould member drum. Hence, the pores of the porous structure are clogged from the outside to the inside. During discharge of the formed food products, the discharge fluid, mostly air, will be directed from the inside to the outside and will help in restore the permeability of the porous structure. Nevertheless, the porous structure has to be cleaned from food particles, proteins, other undesirable substances/particles and/or a biofilm, including the biofilm adhering to the outer surface of the porous structure as well as to all internal surfaces across the thickness of the porous structure in order to prevent colonization and growth of bacteria. Biofilm is a film that sticks to surfaces and composed of both organic residues and multiplying microorganisms. It is formed by bacteria present even in purified water which bacteria adhere to the pore surfaces.

Due to the open pore structure the entire surface area between the pore surface and biofilm is large. Only after cleaning and removal of the entire biofilm the surfaces can be successfully disinfected.

The cleaning process of the mould drum can comprise one or more of the following steps; In a pre-clean step the outside of the mould drum will be rinsed with, preferably cold, water for example by a spray arm provided with nozzles and thereafter the passages and the porous structure of the mould drum will be rinsed with, preferably cold, water inside out, the so called backward flushing, thus reverse to the direction of filling the cavities with food mass. In a next possible cleaning step, the mould drum will be backward flushed with a detergent, for example soap or the like. The temperature is preferably less than 50° C. This step can be followed by rinsing the outside of the mould drum with cold water. Thereafter the mould drum can be cleaned via backward flushing with a disinfectant at a temperature of preferably less than 50° C. The outside of the drum can be rinsed again with cold water. Thereafter, air under pressure above atmospheric pressure can be backward flushed via the passages inside out through the porous structure of the mould drum in order to dry the passages and the porous structure of the entire drum. This cleaning process can be extended with additional rinsing steps with water directed to the outside of the mould member and/or via backward flushing.

According to the present invention, for cleaning, each passage of the drum can now be connected to a two-phase-cleaning source. Hence, the cleaning is carried out with a two-phase material. One phase can be for example a liquid and the other a gas. Other possible combinations are fluid/solid-particles or gas/solid particles. Another option is a cleaning material comprising three phases, i.e. gas/liquid/solid particles. During cleaning, at least one phase can undergo at least a partial phase change.

The two phase cleaning material is a fluid/gas- and/or fluid/effervescent-agent-mixture.

Mould drums can be designed in numerous ways e.g. a single piece plastic porous structure connects to a support member, multiple plastic porous inserts fixedly connected and/or releasable connected to a support member, etc. The support member and/or other parts of the drum can be made from solid plastic but other materials such as stainless steel

Another subject matter of the present invention is a method to clean a mould drum with a multitude of product cavities in a multitude of rows, each cavity having a porous bottom- and/or sidewall the cavities in one row being connected with a passage, the passage extending parallel to the center-axis of the drum from one front end, wherein a foam and/or a two phase cleaning fluid is utilized to clean the product cavities and/or the passages.

The disclosure made regarding this embodiment of the present invention also applies to other embodiments and vice versa. The disclosure made regarding this subject matter of the present invention can be combined with other subject matters of the present invention.

This invention relates to a method to clean a mould drum for producing moulded food products. The food product is moulded in cavities, which have at least partially a porous structure. Each cavity is connected to a passage that preferably extends parallel to the longitudinal rotational axis of the drum. The passage extends until at least one front end of the drum.

According to the present invention, a foam and/or a two phase cleaning fluid is utilized to clean the product cavities and/or the passages.

Regarding the two phase cleaning fluid, reference is made to the disclosure above.

Preferably, the passages and the porous structures are cleaned by a so called backward flushing, i.e. the cleaning material flows from one front end of the drum through the porous structure to the ambient.

In a preferred embodiment of the present invention backward flushing with a gas/cleaning liquid mixture will be used to clean the inside of the porous structure. Gas is added to the chemical cleaning agent and/or cleaning water in. The mixture, a so called two-phase flow, will be forced through the porous structure preferably such that the flow through the porous structure is a turbulent flow which causes high impact stress on the surfaces to be cleaned due to the liquid component with relatively high viscosity and high density and due to the gas component with high velocity in combination with a reduced pressure drop across the porous structure. A turbulent flow is preferred in order to loosen and ultimately remove the biofilm and is also useful in loosen particles and other substances from the porous structure and further it will help in the removal of trapped and dislodged particles.

The flow of the two phases will preferably be a co-current flow wherein both phases gas and liquid flow in the same direction two-phase flow can be arranged in several volumetric ratios of gas/liquid.

When applying a combination of relatively much gas and relatively little liquid, a so-called droplet impact where liquid droplets are dispersed in a gas, preferably air, the velocity of the mixture can be, given a certain pressure drop, almost as high as the velocity of gas without droplets. The impact stress is high due to the high velocity of gas and a high viscosity/density of liquid.

Alternatively, gas is dispersed as bubbles in liquid at a relatively low velocity at a given pressure drop.

Backward flushing with a two-phase flow with the right ratio of gas/liquid and with the right chemicals, temperature, pressure and time is highly effective in cleaning the pore structure of a mould member.

Preferably, the volumetric ratio gas/liquid and the corresponding temperature will be determined by the allowable pressure drop across the porous structure for example such that no deformation of the porous structure/mould member will occur.

The backward flushing, preferably with a two-phase flow can be continuous. In another embodiment the flow of cleaning liquid is continuous and the gas flow is intermittent, preferably pulsatile, with predetermined or stochastic time-intervals. As soon as the gas flow stops the cleaning liquid fills the entire pore structure until the gas flow is start again. This method can help in loosen particles within the porous structure and removing these particles from the porous structure.

In a cleaning process and/or cleaning program, the process steps described above can be used in all kind of combinations for example pre-clean step with cold water, cleaning with one or more detergents, utilizing a disinfectant, drying with gas, particularly air, etc. . . .

In a preferred embodiment, the pore structure and the porous bottom wall and sidewalls will be cleaned by backward flushing a liquid cleaning agent via the passages of the mould drum into the pores of the porous structure. The porous structure remains at least partially filled with the liquid cleaning agent. Thereafter a gas at high velocity can be introduced by backward flushing in order to create a two-phase flow.

In a further preferred embodiment, a cleaning process can consist of multiple one-phase flow steps as for instance cleaning a mould member via backward flushing with a detergent to loosen particles etc. When finished the one-phase flow steps, a two-phase gas/liquid flow can be applied. The cleaning process can be finished with other one-phase flow steps including a step to dry the mould member.

In the above described preferred embodiments the two-phase flow is co-current; both the gas flow and the liquid flow have the same direction. However, all described embodiments are not limited to a co-current flow and not to the direction of the flow, i.e. from the front end through the passage to the porous structure or reverse. The cleaning can take place in a cleaning apparatus wherein the mould drum will be placed within a closed chamber/tank or a closed chamber is created around the external contour of the mould drum.

Preferably, a foam is produced in the passages and/or in the porous bottom- and/or sidewall. The foam has a large surface are and hence improves cleaning of the pores.

In a preferred embodiment, the drum is at least partially submerged in a cleaning liquid. This cleaning method is preferably applicable for fragile drums and/or fragile porous structures. During cleaning, the drum can be moved, preferably rotated in the cleaning liquid. A fluid flow through the passages and the pores of the porous structure as described can be utilized.

After production of food products, the inside of the drum, the porous structure and the outside of the mould drum need to be cleaned. Therefore, soaking is advantageously while all these areas of the drum will be cleaned in this cleaning method at once.

A further advantage of a submerged mould drum will be that the entire drum will be heated more or less evenly. In a cleaning embodiment using backward flushing as main cleaning method, pumping a heated fluid via a passage through at least a partially porous plastic structure will result in temperature difference and therefore thermal stress between the several parts out of which the drum is designed (inner parts versus outer parts drum), the difference in coefficients of expansion of the used materials will result in additional thermal stress. Therefore, cleaning fluid should also be provided to the inside of the mould drum. Preferably, particularly when the drum is not submerged in a cleaning fluid, all passages will be provided with fluid simultaneously to prevent further thermal stress between different spots of the mould member. In a submerged mould drum all parts are provided with fluid at once.

Another advantage of the submersion of the drum in a cleaning fluid in comparison to a cleaning embodiment using backward flushing is that there is no material stress due to the standstill fluid. The result will be that, when applying UHMW-PE as porous material, the temperature of the cleaning fluid in the tank can be during continuous use as high as 82° C., much higher as in above described embodiments during pumping of the cleaning fluid through the porous structure. The high cleaning temperature is advantageously in order to keep the cleaning time of the mould drum acceptable.

All kind of cleaning processes can be used related to a at least partially submerged drum. In one embodiment, the mould drum will be soaked in chemicals, a detergent, preferably in liquid form or as a foam, for a predetermined period of time such that the adhesion forces between the pore surfaces and trapped particles etc. will be removed and the particles etc. will be dislodged. In a preferred embodiment, the cleaning liquid in the tank will be under pressure such to assure that the liquid will fill all pores across the entire thickness of the porous structure. This pressure can be due to gravity, but the entire tank in which the drum is at least partially submerged can also be set under pressure.

In a preferred cleaning process first the loose particles, undesired substances, biofilm, and/or the used chemicals can be removed from the mould drum. This step can be done by backward flushing the filtered chemical cleaning agent, in this case for example a detergent, preferably with low pressure while the drum is still, at least partially, immersed in a tank. More preferably the tank will be drained, filled with a suitable rinsing agent and the drum will be cleaned with backward flushing preferably with low pressure.

In another embodiment, the loose particles etc. will be removed after draining the tank or with the drum above the fluid level of the tank or at a remote location outside the tank. This can be done by flushing or backward flushing a suitable rinsing agent preferably with low pressure.

In a preferred next cleaning step, the mould drum will be immersed again in a tank with another chemical, a disinfectant, in which the drum will be soaked over a predetermined period of time. All remarks above regarding the use of a detergent and rinsing the drum after use of a detergent are also applicable regarding the use of a disinfectant.

In a final step the mould drum can be dried with gas, preferably air, for example via backward flushing and/or by heating the entire drum, preferably for a predetermined period of time.

In another preferred embodiment, the described method can be extended by a step wherein after soaking with a first chemical, rinsing with the same chemical in and/or outside the tank can take place. Further a step wherein after soaking with a second chemical, rinsing with the same chemical in and/or outside the tank can take place.

In another preferred embodiment, the submerged mould drum can be subjected to a two-phase cleaning process. After soaking preferably for a predetermined period of time, for instance with a detergent to loosen particles etc. pressurized gas will be directed with high velocity via backward flushing via the passages and through the porous structure of the mould drum. In this way, a two-phase flow will occur. Preferably the liquid in the tank will be under pressure such to assure a two-phase flow which is well mixed.

Instead of pressurized gas a preferably premixed gas/liquid flow can be directed to the mould drum via backward flushing. In a further embodiment, the mould drum can be subjected to a two-phase cleaning process after draining the tank or above the fluid level of the tank or at a remote location outside the tank.

All above mentioned steps describing the cleaning process of a submerged mould drum can be exchanged and/or extended by applying vacuum to the fluid in the tank in order to remove the loosen particles, cleaning fluid, rinsing fluid, etc. via the passages of the drum through the porous structure and out of the tank. This can be done in combination with a low overpressure applied to the passages of the drum to initiate circulation through the at least porous structure of the mould drum.

In a further preferred embodiment, the cleaning fluid in which the mould drum is submersed will be heated, preferably to its boiling temperature, preferably by microwave energy. The boiling action preferably does not only take place at the surface of the drum but even within the porous structure and loose particles etc. will be removed together with the flow, particularly created by the boiling action. However, this embodiment has limitations with respect to plastic porous structures due to the mechanical and thermal properties of porous plastic. The boiling action within the pores can be reduced by position the tank and mold in a microwave oven. In that case the porous structure is subjected to somewhat lower temperatures while the heat is directed to the fluid filled tank itself.

Preferably, drum rotates during cleaning.

Preferably, peracetic acid is used as a cleaning agent.

Preferably, the fluid pressure used to clean the mould member will be maximum 1 bar but preferably maximum 0.5 bar above ambient pressure. The temperature of the cleaning fluid will preferably not exceed 40° C. but preferably 30° C.

In another preferred embodiment instead of long cleaning intervals with a detergent and long cleaning intervals with a disinfectant, multiple relatively short time repetitive backward flushing cleaning actions will be applied.

For all discussed embodiments, the flow, one-phase flow as well two-phase flow, is preferably directed inside out, i.e. backward flushing, the mould member due to the fact that clogging of the pores is initiated from the outside of the mould member during filling the cavities with a food mass. However, for all disclosed embodiments, although it is not preferable, backward flushing can be reversed in its flow direction, i.e. forward flushing. A combination of both flows preferably repeatedly alternated can help in loosen particles etc. Trapped particles not able to loosen and/or to remove with an inside out flow can be dislodged and even removed with an outside in flow, in case the dislodged particles will not be removed, an additional inside out flow will initiate removal from the mould member. However, the cleaning time and complexity of the cleaning apparatus will increase.

Important in cleaning a porous structure is that the permeability of the structure after cleaning will remain the same as it was right after producing the mould member such that a mould member can be re-used for an acceptable number of times.

Multiple cleaning solutions, used in separate cleaning steps or in combination with other cleaning solutions, can be used to remove organic, inorganic and biological residues. Film layers as biofilm should be removed entirely to prevent further bacterial growth and in order to be effective with a pasteurization step and/or disinfecting step. Cleaning agents are in general useful for spray washing surfaces, tanks, piping and all kind of apparatus, however due to the small pore size of the porous structure it is preferable to use cleaning agents directed to use within a porous structure which cleaning solutions are able to dissolve particles deep within the porous structure. In that case the dissolved particles will be entrained with the cleaning liquid away from the porous structure.

The pH value of the cleaning solution (detergent) should be in a certain range and a surfactant can be add in order to influence the surface tension of the cleaning liquid such that loosen and removing of particles etc. will be improved. Especially in combination with a two-phase flow the surface tension of the cleaning liquid should be in a certain range in order to allow the forming of droplets.

By filling food mass in a plastic porous cavity of a mould member, plastic will be colored within the pores. Therefore, it is important to clean the porous structure as early as possible in order to remove stains. A pure chlorine solution or a high bleach concentration can, depending on the applied plastic such as UHMW-PE, not be used while bleach will increase the pore size of the plastic. Therefore, peracetic acid, e.g. acetic acid and hydrogen peroxide, or a solution with peracetic acid is preferred to use. Acetic acid is useful in the removal of stains and hydrogen peroxide is useful as a disinfectant and as a bleaching agent.

Peracetic acid will also dissolve scale but has a low pH and is not able to remove for instance proteins. To prevent that the pore structure after use will get clogged a cleaning step with a detergent with high pH is needed.

Final rinsing is preferably with bacteria-free water. Thereafter the mould drum can be dried in a final step by air via backward flushing or by warm up the entire drum during a predetermined period of time.

Preferably the permeability of a cleaned mould member will be validated right after finishing the cleaning process. This can for example be done with a vision system that checks the surface for example of the mould cavity and/or by measuring the pressure drop of a gas and/or fluid-flow at a certain velocity. Several pressure sensors can be included in the drum, so that local differential pressures can be measured and an insufficiently cleaned area can be located. Further cleaning should be performed in case the permeability is not within a certain range in order to prevent bacterial growth in case the mould member is in storage and/or rapid clogging of the pores of the porous structure as soon as the drum is back into production.

In another preferred or inventive embodiment of the present invention, the mould drum is cleaned first by applying a cold treatment to the mould drum and secondly by removing solid particles, like food particles, proteins and/or other substances/particles/biofilm from the mould drum.

The disclosure made regarding this embodiment of the present invention also applies to other embodiments and vice versa. The disclosure made regarding this subject matter of the present invention can be combined with other subject matters of the present invention.

Surprisingly, it has been found that substances which stick to the drum during production, like particles, proteins, etc. which stick to the outer surface of the mould drum and/or are entrapped in the porous structure will get brittle/glassy by freezing them. An additional, preferred mechanical action for instance vibration and/or a fluid flow will loosen these particles by removing the remaining adhesion forces between particle and surface drum. Thereafter, a fluid flow will transport the particles out of the porous structure and/or from the surface of the drum and away from the mould drum.

The cleaning of the mould drum can take place in a cleaning apparatus. The drum can be placed within a closed insulated chamber/tank or a closed chamber can be created around the external contour of the mould drum. In a preferred first step air within the chamber and within the porous structure of the mould drum can be dehumidified in order to prevent that during the succeeding cold treatment the pores of the porous structure will get blocked by ice crystals. Dehumidifying can be achieved by replace air within the chamber by dried air but preferably by vacuuming the closed chamber for instance within a pressure range of 0.012-0.123 bar and a corresponding temperature range of 10° C. till 50° C. such that water in the air will evaporate. Vacuuming should be performed gentle in order to prevent damage of the pore structure during the evaporation of water.

In a second step the mould drum will be subjected to a cold treatment such that the pores of the porous structure will not get blocked. The cold treatment results in a temperature reduction of the surface of the mould drum and/or its porous structure and/or channels within the mould drum of −1-−200° C., preferably, −3-−40° C.

In a first embodiment the cold treatment can performed with a liquid gas, e.g. liquid nitrogen LN₂. The liquid gas, here nitrogen, preferably evaporates and the resulting gas is provided to the cylindrical surface of the drum and/or forced through the pores of the porous structure. Liquid gas will be added preferably to the bottom of a chamber in which the drum is provided for cleaning, will evaporate and gas will come in contact with the outer circumference of the drum and/or will penetrate within the pore structure. This can be inside out (backward flushing) and/or outside in (forward flushing). Starting point of this process can be a chamber at atmospheric conditions, but preferably the vacuumed closed chamber according to the first step is utilized. Due to evaporation of liquid gas a large volume of gas will develop, resulting in an increase of the pressure within the chamber. The process parameters can be controlled such that thermal tension stress and pressure build-up of the gas within the pore structure does not damage the structure and will not, in case the mould drum is made out of different materials with different expansion coefficients, damage the drum design. The duration of the cold treatment process should be as short as possible, but long enough to freeze the substances to be removed and reduce the binding force between these substances and the porous structure of the drum. Further the gas is preferably able to escape from the chamber in order to prevent pressure build-up.

According to a second and/or an additional method, a more controlled flow of gas, preferably nitrogen containing gas through the pore structure will be achieved by directing gas to the cleaning apparatus and directly through the pore structure. In case of cleaning inside out, reverse to the direction of filling the cavities with food mass during production, gas will be directed to each passage of the drum via a distributor in the cleaning apparatus or a distributor in the drum. Via the passages gas will exit the mould drum via the porous structure of the cavities. Alternatively or additionally the drum will be cleaned outside in. Gas can be directed to the porous cavities at the outer circumference of the drum via nozzles but preferably gas will be directed to the space between the outer circumference of the drum and the closed chamber designed around the outer circumference of the drum. Via the passages gas will exit the mould drum.

The third preferred or inventive embodiment of the cold treatment is similar to the second embodiment. However, pressurized carbon dioxide CO2 containing gas will be used instead of nitrogen gas N2. Gas under pressure will directed from the gas supply tank to the cleaning apparatus/chamber. Advantageously, the initial temperature of carbon dioxide gas will be higher compare to nitrogen gas. Safety must be taken into account.

The gas which is utilized to clean the drum preferably has a temperature of −1-−120° C., preferably −3-−40° C.

Depending on the cleaning parameters in the previous steps, the degree of pollution, the adhesion forces, etcetera the dislodged particles may already be removed from the mould drum.

If not, a mechanical force like vibration and/or a fluid flow such as water, preferably water with a reduced freezing point, a cleaning agent, a disinfectant or gas will be applied during and/or after the cold-treatment. The fluid can flow through the passages and porous structure of the mould drum preferably inside out and/or outside in in order to remove the entrapped and dislodged particles from the porous structure and other parts of the mould drum and collect them remote from the mould drum.

The cleaning fluid can be filtered and be recycled.

Beneficial in the cleaning procedure of the mould drum is to know when and to be sure that the drum is clean and to know that when and that the porous structure is open and clean. This assures on the one hand that the cleaning process is not unnecessary extended and on the other hand that the drum and the porous structure of the mould cavities is sufficiently clean. This equally applies to cleaning of the drum with a two-phase-cleaning source, to cleaning the drum by submerging it at least partly in a cleaning liquid and to cleaning the drum by applying it to a cold treatment.

According to a preferred or inventive embodiment of the present invention, the cleaning process is adapted and/or controlled by a control step wherein the flow resistance of the porous structure of at least one cavity in one row of cavities, preferably the flow resistance of one entire row of cavities and even more preferably in each row of cavities of the drum is measured and compared to a reference value and/or analyzed over time. As long as the flow resistance, which can be for example measured according to the pressure needed to achieve a certain flow rate and/or the pressure drop over the porous structure and/or the pressure before the porous structure is not reduced to a certain pressure drop, preferably the pressure drops of the new drum, the cleaning process is not terminated. According to another preferred or inventive embodiment or an even more preferred embodiment, the initial pressure drop is measured and the cleaning process, for example its duration and/or the temperature of the cleaning fluid and/or the cleaning substance used is selected. In case the change of the pressure drop over the porous structure is monitored over time, preferably the cleaning is not terminated as long as the pressure drop of the porous structure still decreases and/or the cleaning method, e.g. temperature of the fluid, its pressure and/or the cleaning substance is changed. Preferably, each row can be cleaned individually. In this case the above said applies for each row. In this case, one row can be cleaned more intensely than another row of porous material of the drum. The pressure drop can be measured before and/or after the porous structure has been dried.

Monitoring whether a porous structure is open can be done by measuring the pressure and/or the flow.

During the cleaning process a fluid source, for example air and/or water and/or cleaning detergent is pumped via passages through the porous structure of the drum. Pressure and/or flow of the fluid source will be monitored, preferably continuously, during the cleaning process.

The longer the cleaning process takes, the more the pressure will decrease and/or the flow will increase until a final value, the value when the drum is clean, is reached. Practice has shown, that this value can be a dependent on the drum configuration, e.g. number of rows, number of cavities, the shape of the cavities, the thickness of the porous material etc.

Before using the drum, a first time in production, preferably a reference measurement of the pressure drop of the drum and/or the pressure of the cleaning fluid to achieve a certain fluid flow should be made which values should be stored and used as reference values.

These values will be the reference values to determine later on if a drum is open, i.e. if the porous structure and/or the fluid passages in the drum are clean. This reference value is preferably measured for each row independently.

The cleaning program, cleaning results, reference measurement pressure and/or flow and monitored pressure and/or fluid flow values can be stored in the apparatus wherein a drum is cleaned or in a central data storage and/or in a storage, for example an RFID on the drum.

In case the drum has a storage element, for example an RFID, the drum can be recognized in the forming apparatus as well as in the cleaning apparatus. History of cleaning such as cleaning program and cleaning result can be extended with the reference measurement of pressure and/or fluid flow and the monitored pressure and fluid flow values.

This history can be stored on the storage element of the drum or the apparatus in which the drum is cleaned. When using multiple cleaning apparatus preferably the history is stored in a central data system to prevent that the storage element of a certain drum will not be updated well or will be out of memory.

By continuously monitoring the pressure and fluid flow of the fluid source it is even possible to stop the cleaning process already as the pressure and flow reaches desired values.

On the other hand, when at the end of the cleaning process the desired values of pressure and flow are not reached, the cleaning process can be extended until the desired values are reached.

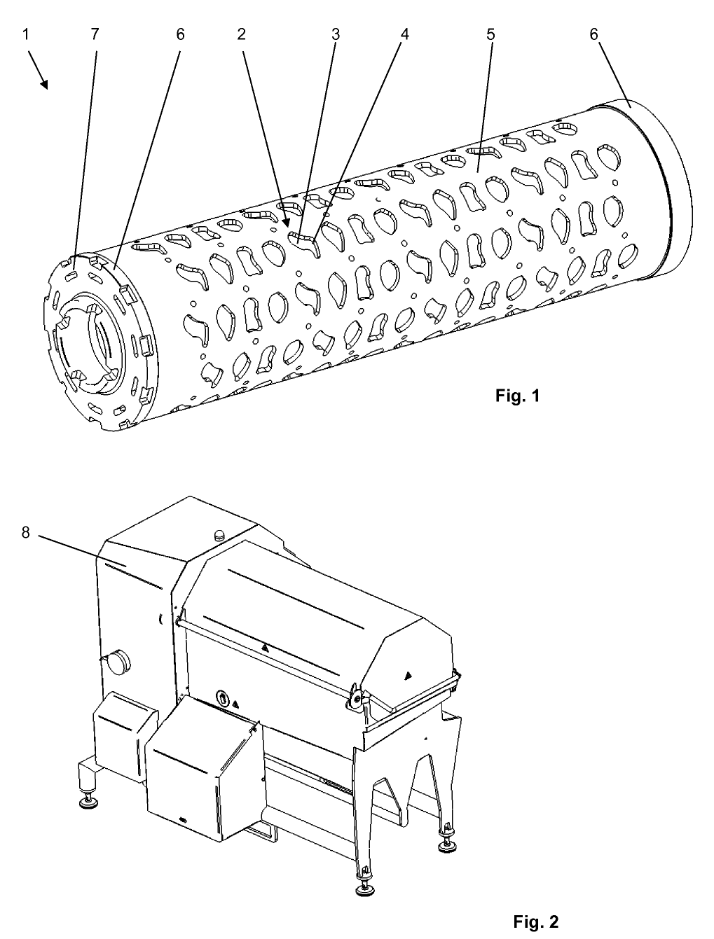

The inventions are now explained according to FIGS. 1 and 2. These explanations are only exemplary and do not limit the scope of protection.

FIG. 1 shows a mould member, in this case a mould drum 1 which is in this embodiment provided with end-caps 6. Product cavities 2 are arranged around the circumference of the drum and open out towards the surface. In its axial extension, the mould drum comprises rows each with a multitude of cavities which are in this embodiment of the drum arranged in parallel. Every individual cavity in a row of cavities is via the porous structure in fluid contact with a passage 7. In the present case one row of cavities comprises sixteen cavities which are filled simultaneously and discharged simultaneously. At least the bottom wall 3 of cavities 2 but preferably also the sidewall 4 will be made of plastic porous material. Drum wall 5 is closed to prevent penetration of food mass in the porous structure during filling and to improve discharge of formed food products from the cavities 2.

FIG. 2 shows a first embodiment of the cleaning apparatus 8. This cleaning apparatus comprises a support frame, which is embodied in the present case as a partial segment of a cylindrical tube. Into this support frame, the mould drum is placed. On each side, the inventive cleaning apparatus comprises cover- and fastening means which can be axially movable. After the drum, has been placed into the support frames, the cover- and/or fastening means are moved towards the drum, until they are in contact with the respective front end. Drive means, preferably motor drive means can be utilized for this movement particularly in order to automatize the cleaning process. The person skilled in the art understands, however, that the means can also be moved manually. At their contact side with the drum, each cover- and/or fastening means comprises sealing means in order to avoid undesired leakage particularly cleaning- and/or drying-fluid leakage between the drum and the cover. During cleaning, the mould drum can be stationary and a distributor, here a spray bar with a multitude of nuzzles, rotates around the drum. The distributor can be motor driven and/or can be rotated by the impulse of the jet that emerges each nozzle. Alternatively, the spray bar is stationary and the drum rotates. The cleaning fluid sprayed on the outside of the drum cleans the surface of the drum and the surface of the cavity. Furthermore, the cover- and/or fastening means comprises a cleaning fluid and/or gas connection. Through this cleaning fluid connection, a cleaning fluid and/or a gas is introduced into the cover and flows as a single- or two-phase-flow from there to the distribution groove, which is connected to all passages of the mould drum. Thus, the passages and/or the porous structure of the cavity can be cleaned which will be explained in further detail later on.

### LIST OF REFERENCE SIGNS

1 mould drum
2 plastic porous product cavities
3 porous bottom wall cavity
4 porous sidewall cavity
5 drum wall
6 end-cap
7 passages
8 cleaning apparatus
9 row of cavities
10 front end of the drum
11 two phase cleaning material source.

1. A mould drum comprising:
a multitude of product cavities in a multitude of rows, each of the cavities having a porous bottom and/or a porous sidewall, the cavities in one of the rows being connected with a passage, the passage extending parallel to a center-axis of the mould drum from one front end,
wherein the passage is connected to a two phase cleaning material source.

2. The mould drum according to claim 1, wherein the cavities are at least partially made from a plastic material.

3. The mould drum according to claim 1, wherein the two phase cleaning material source is a fluid/gas- and/or fluid/effervescent-agent-mixture.

4. A method to clean a mould drum with a multitude of product cavities in a multitude of rows, each of the cavities having a porous bottom and/or a porous sidewall, the cavities in one row being connected with a passage, the passage extending parallel to a center-axis of the mould drum from one front end, wherein a foam and/or a two phase cleaning fluid is utilized to clean the product cavities and/or the passages.

5. The method according to claim 4, wherein the mould drum is subjected to a cold treatment and by subsequently by removing solid particles.

6. The method according to claim 5, wherein a gas is utilized to cool the mould drum during the cold treatment.

7. The method according to claim 6, wherein the gas is forced through the porous bottom and/or the porous side wall.

8. The method according to claim 4, wherein the foam is produced in the passages and/or in the porous bottom- and/or the porous sidewall.

9. The method according to claim 4, wherein the mould drum is at least partially submerged in a cleaning liquid.

10. The method according to claim 4, wherein the mould drum rotates during cleaning.

11. The method according to claim 4, wherein peracetic acid is used as a cleaning agent.

12. The method according to claim 1, wherein coloring of the porous bottom and/or the porous sidewall due to use of the mould drum during production is at least reduced and/or that the porous bottom and/or the porous sidewall is disinfected.

13. The method according to claim 5, wherein peracetic acid is used as a cleaning material.

14. The method according to claim 4, wherein the method comprises multiple repetitive backward flushing cleaning actions with detergent and/or disinfectant.

15. The method according to claim 4, wherein a pressure of the cleaning fluid at an entrance of the mould drum does not exceed 3 Bbar and/or a temperature of the cleaning fluid does not exceed 40° C.

16. The mould drum according to claim 1, wherein the two-phase cleaning source comprises a liquid and a gas.

17. The method according to claim 4, wherein the two-phase cleaning liquid comprises a liquid and a gas.

18. The method according to claim 17, wherein the liquid and the gas flow in the same direction.

19. The method according to claim 17, wherein the method comprises filling the porous bottom and/or the porous sidewall with the liquid and then introducing the gas by backward flushing to crease a two-phase flow.

20. The method according to claim 19, wherein the mould drum rotates during cleaning.
